(19) United States
(12) Patent Application Publication
(10) Pub. No.: US 2023/0422194 A1
(43) Pub. Date: Dec. 28, 2023

(54) SYSTEM AND METHOD FOR TIME SYNCHRONIZATION OF ACCESS DEVICES

(71) Applicants: Rohin PARKAR, Ponda (IN); Aniket SHET, Bicholim (IN); Mohinish NAIK, Cortalim (IN); Malcolm DSOUZA, Margao (IN)

(72) Inventors: Rohin PARKAR, Ponda (IN); Aniket SHET, Bicholim (IN); Mohinish NAIK, Cortalim (IN); Malcolm DSOUZA, Margao (IN)

(21) Appl. No.: 18/037,848

(22) PCT Filed: Nov. 19, 2021
(86) PCT No.: PCT/IN2021/051084

§ 371 Date: May 19, 2023

(30) Foreign Application Priority Data
Nov. 19, 2020 (IN) 202021038167

(51) Int. Cl. H04W 56/00; G07C 9/00

(52) U.S. Cl. CPC H04W 56/0015; G07C 2009/00769; G07C 9/00571

(57) ABSTRACT

Disclose is a system (100), the system (100) including: the access devices (102) configured to communicate within; wherein a first access device (102a) of the access devices (102) is configured to generate a health message (154) and a control circuitry (104) that is coupled to the access devices (102), and configured to read an initial device time from the health message (154), thereafter compare the initial device time with a controller time, thereafter determine first auto drift correction parameters based on a result of the comparison, wherein a first time correction is applied to the initial device time to generate an intermediate device time; and compare the intermediate device time with the controller time and determine second auto drift correction parameters, wherein a second time correction is applied to the intermediate device time to generate a final device time.

### TECHNICAL FIELD

The present invention relates to a field of synchronizing time of multiple access devices in a wireless network. More particularly, the present invention relates to a system and a method for synchronizing time of the multiple access devices with control circuitry over a communication network.

### BACKGROUND

Background description includes information that may be useful in understanding the present invention. It is not an admission that any of the information provided herein is prior art or relevant to the presently claimed invention, or that any publication specifically or implicitly referenced is prior art.

Access Control System allows organization or owner to restrict access of a resource. This helps organizations to control and monitor the access and usage of resource by an individual having access to it.

Traditional access control systems include a reader also known as access devices, actuator, and a central controller. The access devices and actuator are electrically connected to central controller in a star network. When user tries to gain access, the access devices is to read the authentication information from user, which is an NFC card data or user fingerprint. It then sends that information to central controller for validation. The central controller trains authentication information of all the users in system. On receiving validation request from the access devices, it validates the user and sends message to actuator to open the restriction. In traditional access control system, the reader is not required to maintain the time as it is directly connected to central controller, which maintains the timing.

The modern access control system is based on wireless mesh technology and replaces the traditional electrical connection between the system components with wireless connection. The wireless connection improves the security and makes it a cost-effective solution as requirement of drawing wires from central controller to access devices and actuators is eliminated. The access control system consists of battery powered access devices, wireless friend device and a gateway. In system, the user authentication is performed at access device itself. This distributed architecture allows higher system reliability but comes with own challenges. The access devices need to have accurate sense of time as access device time is used by system to determine when user gained or released access to resource or when user is allowed to access the resource. The user access time is used by other components of access control system to generate attendance of user. Therefore, the access device time cannot go wrong in any situation. The need is felt for a smart mechanism to correct the access device time in case of time drift.

There is, therefore, a requirement in the art for a means to ensure accurate time synchronization between readers and gateway for access control in a wireless mesh network.

### SUMMARY

One aspect of the present disclosure provides a system, the system including a plurality of access devices configured to communicate to each other. The system further includes a first access device of the plurality of access devices is configured to generate a health message. The system further includes a control circuitry that is coupled to the plurality of access devices, and configured to read an initial device time associated to the first access device from the health message received from the first access device. The control circuitry is further configured to compare the initial device time with a controller time associated to the control circuitry. The control circuitry is further configured to determine first auto drift correction parameters based on a result of the comparison, in that a first time correction is applied to the initial device time based on the first auto drift correction parameters to generate an intermediate device time, and compare the intermediate device time with the controller time and determine second auto drift correction parameters based on a result of the comparison, in that a second time correction is applied to the intermediate device time based on the second auto drift correction parameters to generate a final device time when a difference between the intermediate device time and the controller time is above a first predefined threshold value.

In some aspects of the present disclosure, the system further includes a communication network that enables the plurality of access devices to communicate to each other.

In some aspects of the present disclosure, the control circuitry is further configured to determine second auto drift correction parameters for the first access device based on a time taken by the first access device to drift to a predefined value.

In some aspects of the present disclosure, the control circuitry is further configured to periodically receive the health message from the first device.

In some aspects of the present disclosure, a main access device is coupled to the first access device and a second access device of the plurality of access devices, and configured to receive a message addressed to the first device from the second device, in that the main device is further configured to store the health message in an internal memory.

In some aspects of the present disclosure, the control circuitry is further configured to generate and provide a notification to the first access device when the difference between the intermediate device time and the controller time is above the predefined threshold value such that the notification enables the first device to perform time synchronization with the main device.

In some aspects of the present disclosure, in which in response to the notification, the first device requests a current time from the main device to perform time synchronization.

In some aspects of the present disclosure, the control circuitry is further configured to perform a network mapping of the plurality of access devices.

In some aspects of the present disclosure, the control circuitry is further configured to determine network parameters based on the generated network mapping, in which the network parameters comprise one of, a hop count and latency between the plurality of access devices.

In some aspects of the present disclosure, the control circuitry is further configured to determine an optimum hop count value for each access device of the plurality of access devices such that messages routed between the plurality of access devices and the control circuitry has a minimal time delay.

In some aspects of the present disclosure, the control circuitry is further configured to generate a list of discovered devices based on the detection.

In some aspects of the present disclosure, the control circuitry is further configured to utilize the network parameters to determine a time delay for different routes in the communication network and provides the time delay for different routes to each access device of the plurality of access devices.

In some aspects of the present disclosure, each access device of the plurality of access devices comprises a battery to provide an electrical energy to perform operations.

In some aspects of the present disclosure, the main device is powered by way of a power supply to provide an electrical energy to perform operations.

In some aspects of the present disclosure, the first device comprises a device clock such that the control circuitry is configured to apply the first time correction and the second time correction by way of the device clock.

In some aspects of the present disclosure, the control circuitry further comprises a controller clock configured to generate the controller time.

In some aspects of the present disclosure, a server that is coupled to the control circuitry, and configured to synchronize time with the control circuitry at predefined time intervals.

In some aspects of the present disclosure, the control circuitry is further configured to periodically synchronize the controller clock with the server and in that, the control circuitry is further configured to correct the controller time of the controller clock when a drift in the controller time and a time of the server is identified.

Another aspect of the present disclosure provides a method for synchronizing time of a plurality of access devices in the communication network. The method including steps of: detecting, by way of a control circuitry of a system, the plurality of access devices once the plurality of access devices is powered ON by transmitting a status signal; transmitting, by way of the control circuitry, a health message to the plurality of access devices to establish a communication in within the communication network; reading, local time of by the control circuitry associated with the first access device from the health message received; receiving the health message by the first access device from the control circuitry and comparing the local time with the time of the controller circuitry; determining first auto drift correction parameters based on the result of the comparison that is applied to the local time of the plurality of access devices based on the first auto drift correction parameters to generate an intermediate access device time; comparing the intermediate device time with the time of the controller clock and determining second auto drift correction parameters based on a result of the comparison; applying a second time correction parameters by the control circuitry to the intermediate device time based on the second auto drift correction parameters; and generating and updating a final device time when a difference between the intermediate device time and the controller circuitry time is above a first predefined threshold value.

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

only, which thus is not a limitation of the present disclosure, and wherein:

FIG. 1 illustrates a block diagram of a system, in accordance with an aspect of the present disclosure; and

FIG. 2 illustrates a flowchart of a method for synchronizing time of a plurality of access devices in the communication network, in accordance with an exemplary aspect of the present disclosure.

To facilitate understanding, like reference numerals have been used, where possible to designate like elements common to the figures.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. Various terms as used herein are shown below. To the extent a term used in a claim is not defined below, it should be given the broadest definition persons in the pertinent art have given that term as reflected in printed publications and issued patents at the time of filing.

The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

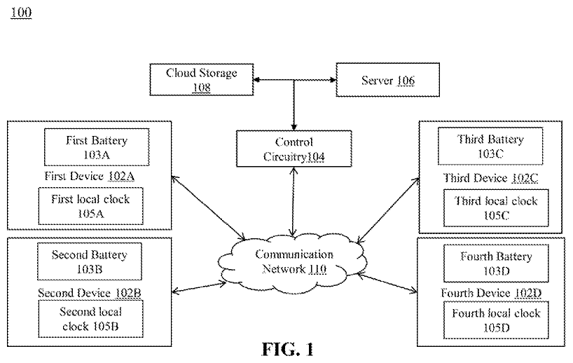

FIG. 1 illustrates a block diagram of a system 100, in accordance with an aspect of the present disclosure. The system 100 may facilitate time synchronizing of plurality of access devices communicating over a mesh network. Not all of the depicted components may be used, however, one or more implementations may include additional components not shown in the figure. Variations in the arrangement and types of the components may be made without departing from the spirit or scope of the claims as set forth herein. Additional, fewer, and/or different components may be provided.

The system 100 may include a plurality of access devices 102 of which first through fourth access devices 102a-102d are shown, a control circuitry 102, a server 106 and a cloud storage 108. Furthermore, one of the first through fourth access devices 102a-102d is the main powered access device 102-C. Additionally, the first through fourth access devices 102a-102d may include first through fourth batteries 103a-103d and first through fourth local clocks 105a-105d. The control circuitry 104 further include a controller clock 107.

The first access device 102a and the second access device 102b with the third access device 102c (i.e., main access device) is shown in the context to show all the possible couplings.

In the illustrated aspect of FIG. 1, the first through fourth access devices 102a-102d, the controller circuitry 104, the server 106 and the cloud storage 108 are communicatively coupled to each other via a plurality of communication networks of which a communication network 110 is shown. The system 100 including the first through fourth access devices 102a-102d, the controller circuitry 104, the cloud storage 108 and the server 106 that are communicatively coupled to each other via the communication network 110 to define a physical access control network. The first through fourth access devices 102a-102d may be deployed at various locations of a facility such as, but not limited to, a building, a warehouse, and the like. Aspects of the present disclosure are intended to include or otherwise cover any type of the facility. Further, the first through fourth access devices 102a-102d may be internet enabled devices that may be configured to communicate with one another and/or the control circuitry 104 over the communication network 110. The first through fourth access devices 102a-102d may form a mesh group where messages from the control circuitry 104 may be broadcasted to nearby access devices of the plurality of access devices 102 and then in turn forwarded to further nearby access devices of the plurality of access devices 102. Such a configuration facilitates to dramatically save wiring and routing involved during installation of the system 100. In an aspect, the plurality of batteries 103 is to provide an electrical energy to perform operations.

The first through fourth access devices 102a-102d may include, but is not limited to, internet of things (IOT) light bulbs, IOT light panels, IOT temperature sensors, IOT humidity sensors, IOT access control readers, IOT range extenders, and the like. It will be apparent to a person skilled in the art that the first through fourth access devices 102a-102d may include any type of the internet enabled device, including known, related, and later developed technologies, without deviating from the scope of the present disclosure. In an aspect, the control circuitry 104 monitors battery powered access control device 104 time by reading health message (154) transmitted from the first access device, which contain name of the device 102c.

The first through fourth access devices 102a-102d are coupled with each other through mesh like network in a communication network 110 and configured to share data/information with each other. At first, the system 100 is powered ON. The control circuitry 104 transmits electrical signal to the plurality of access devices 102, the server 106 and the cloud storage 108. The first through fourth access devices 102a-102d transmits a status signal 152 to determine power on state of each of the first through fourth access devices 102a-102d. The status signal 152 is generated by the plurality of the batteries 103 of which the first through fourth batteries 103a-103d is assembled in the first through fourth access devices 102a-102d. In an aspect, firstly the main powered access device 102-C powers ON and transfers the status signal 152 to the remaining access devices 102a, 102b and 102d. In an aspect, the main access device 102c is coupled to the first access device 102a and a second access device 102b of the plurality of access devices 102, and configured to receive a message addressed to the first device 102b from the second device 102b. The main device 102c is further configured to store the health message 154 in an internal memory. In an aspect, the main access device 102c, which is the battery powered access device is electrically connected to a locking system, which control the access to restricted area and wireless connected to the control circuitry 104 over the mesh network.

Furthermore, the first access device 102a of the plurality of access devices 102 is configured to provide the health message 154 to the control circuitry 104 to check the on/off state of the control circuitry 104. The control circuitry 104 receives the health message 154 when the control circuitry 104 is switched ON. The control circuitry 104 transfer back the acknowledgment stating the power on state of the control circuitry 104. In an aspect, the health message 154 may include but not limited to data packet and ping message. Thereby, the communication network 110 is developed and communication is established. The control circuitry 104 generates a list of discovered access devices 156 by the health message 154 and the status signal 152 generated by the first through fourth access devices 102a-102d. In an aspect, the list of discovered access devices 156 may include information such that which include but not limited to the IP address of the device, mac address of the device, credential information, location information and network related parameters. Thereafter, the control circuitry 104 performs network mapping of discovered access devices and finds the network related parameters that include, but not limited to, hop count and latency between the plurality of access devices 102. Based on the network parameters, the control circuitry 104 describes with an optimum hop count value for each access devices of the plurality of access devices 102 so that messages can be routed on the mesh network with a minimum time delay.

The control circuitry 104 may include suitable logic, instructions, circuitry, interfaces, and/or codes for executing various operations. The control circuitry 104 may be coupled to the first through fourth access devices 102a-102d. The control circuitry 104 may be configured to receive, from the second access device 102b, the health message 152 over the communication network 110. In other words, the control circuitry 104 may be configured to receive the health message 152 associated with the first access device 102a via the second access device 102b.

The control circuitry 104 reads the time associated with the first through fourth access devices 102a-102d from the first through fourth local clock 105a-105d of the plurality of local clock 105 associated to the plurality of access devices 102 by the health message 154 received from the plurality of access devices 102. In an example, the first access device 102a of the first through fourth access devices 102a-102d requests time to the control circuitry 104 by transmitting the health message 154. In an aspect, the control circuitry 104 is further configured to determine second auto drift correction parameters for the first access device 102a based on a time taken by the first access device 102a to drift to a predefined value.

The control circuitry 104 transmits the time of the controller clock 107 to the first access device 102a from the first through fourth access devices 102a-102d. Further, the control circuitry 104 may compare the received local time i.e., the initial time from the second local clock 105A of the first through fourth local clock 105a-105d with the time of the controller clock 107. Based on the comparison, the control circuitry 104 determine first auto drift correction parameter that is applied to the first local time 105A of the first access device 102a of the first through fourth access devices 102a-102d based on the first auto drift correction parameters to generate an intermediate device time. Thereafter, the control circuitry 104 compares the intermediate device time with the time of the controller clock 107 of the control circuitry and determine second auto drift correction parameters based on the result of the comparison. A second time correction is applied to the intermediate device time based on the second auto drift correction parameters to generate a final device time when a difference between the intermediate device time and the time of controller clock is above a first predefined threshold value. In an aspect, the plurality of access device 102 periodically transmits time to control circuitry in the form of the health message 154. In an aspect, the control circuitry 104 applies correction to the local time i.e., the initial time of the first through fourth local clock 105a-105d.

In another aspect, the control circuitry 104 is further configured to generate and provide a notification to the first access device 102a of the first through fourth access devices 102a-102d when the difference between the intermediate device time and the controller time is above the predefined threshold value such that the notification enables the first access device 102a of the first through fourth access devices 102a-102d to perform time synchronization with the main powered access device 102c. In an aspect, the first access device 102a requests the current time from the main powered access device 102c to perform time synchronization in response to the notification generated by the control circuitry 104. In another embodiment, the control circuitry 104 is further configured to perform network mapping of the plurality of access devices 102. In another embodiment, the control circuitry 104 is further configured to determine network parameters based on the generated network mapping. In an aspect, the network parameters includes one of, a hop count and latency between the plurality of access devices 102. In another aspect, the control circuitry 104 is further configured to determine an optimum hop count value for each access device of the plurality of access devices 102 such that messages routed between the plurality of access devices 102 and the control circuitry 104 has a minimal time delay. In another aspect, the time server 106 is coupled to the control circuitry 104, and configured to synchronize time with the control circuitry 104 at predefined time intervals. In another aspect, the control circuitry 104 is further configured to periodically synchronize the controller clock 107 with the server 106. The control circuitry 104 is further configured to correct the time of the controller clock 107 when a drift in the time of the control circuitry 104 and a time of the server 106 is identified.

The cloud storage 108 may be configured to store the logic, instructions, circuitry, interfaces, and/or codes of the control circuitry 110 for executing various operations. Further, the cloud storage 108 may be configured for storage and retrieval of data associated with the system 100. Examples of the cloud storage 108 may include but are not limited to, a centralized database, a distributed database, a relational database, a NoSQL database, a cloud database, an object-oriented database, a hierarchical database, a network database, and the like. In some aspects of the present disclosure, a set of centralized or distributed network of peripheral memory devices may be interfaced with the server 106, as an example, on a cloud server. Aspects of the present disclosure are intended to include or otherwise cover any type of the database 112 including known, related art, and/or later developed technologies.

The communication network 110 may include suitable logic, circuitry, and interfaces that may be configured to provide a plurality of network ports and a plurality of communication channels for transmission and reception of data related to operations of various entities (such as the first through fourth access devices 102a-102d, the control circuitry 104, and the server 106) of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 110 may be associated with an application layer for implementation of communication protocols based on one or more communication requests from the first through fourth access devices 102a-102d, the control circuitry 104, and the server 106. Communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In a preferred aspect of the present disclosure, the communication network 110 may include one of, an Internet of Things (IOT) network, a Bluetooth Low Energy (BLE) network, and a ZIGBEE network, and the like. Aspects of the present disclosure are intended to include or otherwise cover any type of communication channels, including known, related art, and/or later developed technologies. In one aspect, the communication data may be transmitted or received via at least one communication channel of a plurality of communication channels in the communication network 108. The communication channels may include a wireless channel. The wireless channel may be associated with a data standard which may be defined by one of a Wireless Local Area Network (WLAN), a Wireless Sensor Network (WSN), Wireless Area Network (WAN), Wireless Wide Area Network (WWAN), the Internet, an infrared (IR) network, a radio frequency (RF) network, and a combination thereof.

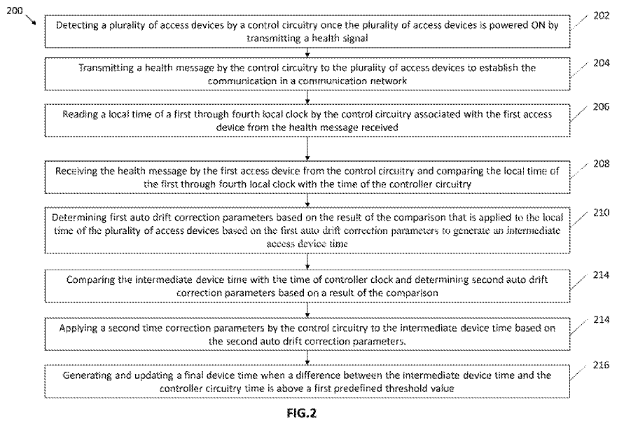

FIG. 2 illustrates a flowchart of a method 200 for synchronizing time of the plurality of access devices 102 in the communication network 110, in accordance with an aspect of the present disclosure.

At step 202, the plurality of access devices 102 of which the first through fourth access devices 102a-102d is detected by the control circuitry 104 once the system 100 is powered ON by transmitting the status signal 152.

At step 204, the health message 15, by way of the control circuitry 104 to plurality of access devices 102 to establish the communication in the communication network 110.

At step 206, the local time of local clock 105a is read by the control circuitry 104 that is associated with the first access device 102a of the first through fourth access devices 102a-102d from the health message 154 received.

At step 208, the health message 154 by the first access device 102a of the first through fourth access devices 102a-102d is received from the control circuitry 104 and comparing the local time of the first through fourth local clock 105a-105d with the time of the controller circuitry 104.

At step 210, a first auto drift correction parameters is determined based on the result of the comparison that is applied to the local time of the plurality of access devices 102 based on the first auto drift correction parameters to generate an intermediate device time.

At step 212, the intermediate device time with the time of the controller clock 107 is compared and second auto drift correction parameters based on a result of the comparison is determined.

At step 214, a second time correction parameters is applied by the control circuitry 104 to the intermediate device time based on the second auto drift correction parameters.

At step 216, a final device time is generated and updated when a difference between the intermediate device time and the controller circuitry 104 time is above a first predefined threshold value.

As will be readily apparent to those skilled in the art, the present embodiment may easily be produced in other specific forms without departing from its essential characteristics. The present aspects are therefore, to be considered as merely illustrative and not restrictive, the scope being indicated by the claims rather than the foregoing description, and all changes which come within therefore intended to be embraced therein.

We claim:

1. A system (100) comprising:
a plurality of access devices (102) configured to communicate to each other; wherein a first access device (102a) of the plurality of access devices (102) is configured to generate a health message (154);
a control circuitry (104) that is coupled to the plurality of access devices (102), and configured to:
read an initial device time associated to the first access device (102a) from the health message received from the first access device (102a);
compare the initial device time with a controller time associated to the control circuitry (104),
determine first auto drift correction parameters based on a result of the comparison, wherein a first time correction is applied to the initial device time based on the first auto drift correction parameters to generate an intermediate device time; and
compare the intermediate device time with the controller time and determine second auto drift correction parameters based on a result of the comparison, wherein a second time correction is applied to the intermediate device time based on the second auto drift correction parameters to generate a final device time when a difference between the intermediate device time and the controller time is above a first predefined threshold value.

2. The system (100) as claimed in claim 1, further comprising a communication network (110) that enables the plurality of access devices (102) to communicate to each other.

3. The system (100) as claimed in claim 1, wherein the control circuitry (104) is further configured to determine second auto drift correction parameters for the first access device (102a) based on a time taken by the first access device (102a) to drift to a predefined value.

4. The system (100) as claimed in claim 1, wherein the control circuitry (104) is further configured to periodically receive the health message (154) from the first device (102a).

5. The system (100) as claimed in claim 1, further comprising a main access device (102c) that is coupled to the first access device (102a) and a second access device (102b) of the plurality of access devices (102), and configured to receive a message addressed to the first device (102b) from the second device (102b), wherein the main device (102c) is further configured to store the health message (154) in an internal memory.

6. The system (100) as claimed in claim 4, wherein the control circuitry (104) is further configured to generate and provide a notification to the first access device (102a) when the difference between the intermediate device time and the controller time is above the predefined threshold value such that the notification enables the first device (102a) to perform time synchronization with the main device (102c).

7. The system (100) as claimed in claim 6, wherein, in response to the notification, the first device (102a) requests a current time from the main device (102c) to perform time synchronization.

8. The system (100) as claimed in claim 1, wherein the control circuitry (104) is further configured to perform a network mapping of the plurality of access devices (102).

9. The system (100) as claimed in claim 8, wherein the control circuitry (104) is further configured to determine network parameters based on the generated network mapping, wherein the network parameters comprise one of, a hop count and latency between the plurality of access devices (102).

10. The system (100) as claimed in claim 8, wherein the control circuitry (104) is further configured to determine an optimum hop count value for each access device of the plurality of access devices (102) such that messages routed between the plurality of access devices (102) and the control circuitry (104) has a minimal time delay.

11. The system (100) as claimed in claim 1, wherein the control circuitry (104) is further configured to generate a list of discovered devices based on the detection.

12. The system (100) as claimed in claim 1, wherein the control circuitry (104) is further configured to utilize the network parameters to determine a time delay for different routes in the communication network (110) and provides the time delay for different routes to each access device of the plurality of access devices (102).

13. The system (100) as claimed in claim 1, wherein each access device of the plurality of access devices (102) comprises a battery (103) to provide an electrical energy to perform operations.

14. The system (100) as claimed in claim 1, wherein the main device (102c) is powered by way of a power supply to provide an electrical energy to perform operations.

15. The system (100) as claimed in claim 1, wherein the first device (102a) comprises a device clock (105) such that the control circuitry (104) is configured to apply the first time correction and the second time correction by way of the device clock (105).

16. The system (100) as claimed in claim 1, wherein the control circuitry (104) further comprises a controller clock (107) configured to generate the controller time.

17. The system (100) as claimed in claim 1, further comprising a server (106) that is coupled to the control circuitry (104), and configured to synchronize time with the control circuitry (104) at predefined time intervals.

18. The system (100) as claimed in claim 17, wherein the control circuitry (104) is further configured to periodically synchronize the controller clock (107) with the server (106) and wherein, the control circuitry (104) is further configured to correct the controller time of the controller clock (107) when a drift in the controller time and a time of the server (106) is identified.

19. A method (200) for synchronizing time of a plurality of access devices (102) in the communication network (110), the method (200) comprising:
detecting, by way of a control circuitry (104) of a system 100, the plurality of access devices (102) once the plurality of access devices (102) is powered ON by transmitting a status signal (152);
transmitting, by way of the control circuitry (104), a health message (154) to the plurality of access devices (102) to establish a communication in within the communication network (110);
reading, local time of by the control circuitry (104) associated with the first access device (102a) from the health message (154) received;
receiving the health message (154) by the first access device (102a) from the control circuitry (104) and comparing the local time with the time of the controller circuitry (104);
determining first auto drift correction parameters based on the result of the comparison that is applied to the local time of the plurality of access devices (102) based on the first auto drift correction parameters to generate an intermediate access device time;
comparing the intermediate device time with the time of the controller clock (107) and determining second auto drift correction parameters based on a result of the comparison;
applying a second time correction parameters by the control circuitry (104) to the intermediate device time based on the second auto drift correction parameters; and
generating and updating a final device time when a difference between the intermediate device time and the controller circuitry (104) time is above a first predefined threshold value.

20. The method (200) as claimed in claim 19, wherein the battery powered device (102-3) is electrically connected to a locking system, which control the access to restricted area and wireless connected to the control circuitry (104) over the mesh network.

21. The method (200) as claimed in claim 19, wherein the control circuitry (104) monitors battery powered access control device (104) time by reading the health message (154) transmitted from the first access device which contain name of the device (102c).
